(19) United States
(12) Patent Application Publication
(10) Pub. No.: US 2005/0283371 A1
(43) Pub. Date: Dec. 22, 2005

(54) Method of selling pre-fabricated houses

(76) Inventor: Paolo Tiramani, Greenwich, CT (US)

Correspondence Address: David C. Jenkins;Eckert Seamans Cherin & Mellott, LLC, 600 Grant Street, 44th Floor, Pittsburgh, PA, 15219, US

(21) Appl. No.: 10/653,603

(22) Filed: Sep. 2, 2003

Related U.S. Application Data
(60) Provisional application No. 60/407,022, filed on Aug. 30, 2002.

(51) Int. Cl. G06F 17/60

(52) U.S. Cl. 705/1; 705/10

(57) ABSTRACT

A method of selling custom prefabricated houses which allows the user to add various options to a house while presenting an image of the house that is updated as the user adds options. The method includes the steps of providing a computer database which includes data representing price charts and images, the price data and images representing various components of the prefabricated house, allowing the user to access the database via a computer and a communications medium, displaying an image of a prefabricated house and an associated price along with a means to allow the user to select options to the house, allowing the user to select optional components to the house, displaying an image of the house with the user selected options included in the image displaying a price associated with the house with user selected options, and storing the user selection for later retrieval.

### CROSS-REFERENCE TO RELATED APPLICATION

This application claims priority under 35 U.S.C. §119(e) to provisional application Ser. No. 60/407,022, filed Aug. 30, 2002, incorporated by reference, and is related to commonly assigned concurrently filed U.S. patent application Ser. No. ______, filed Aug. ______, 2003, entitled “MODULAR PREFABRICATED HOUSE” (Attorney Docket No. 286357-00004-1).

### BACKGROUND OF THE INVENTION

1. Field of the Invention

This invention relates to a method of selling houses and, more specifically, to a method of selling prefabricated houses through a communication medium.

2. Background Information

The custom design, pricing and purchasing of a custom house is a substantial undertaking fraught with risk, the possibility of error and unforeseen charges; a task so large that it is typically only dealt with by professionals. Accordingly, prefabricated houses have been manufactured having limited options. For example, “modular homes” typically include two halves of a house which may be transported over roadways and assembled at a building site. Mobile homes include a single unit which is essentially entirely premade. Other prefabricated homes are designed to “unfold” into a layout that is larger than what may be transported by a truck. Still, each of these methods of constructing a house rely on the user purchasing a house built upon a single model, with limited options. These homes are also, typically, sold in pre-set models.

Alternatively, in the case of prefabricated homes, the user may be simply presented with a list of all available options. Such lists are often confusing and require the user to mentally construct an image of the home. However, given the large number of options, the user is not likely to form a proper image of the home.

Thus, there is a need for a method of selling prefabricated homes which allows the user to see an image of the house as various options are added, or taken away from, a basic model.

There is a further need for a method of selling prefabricated homes wherein sets of related options are presented to the user in sequence so the user may make discrete selections.

There is a further need for a method of selling prefabricated homes wherein the user may select multiple modules for a prefabricated house that may be joined to each other at one of multiple connection points.

### SUMMARY OF THE INVENTION

These needs and others are met by the present invention which provides a method of selling a prefabricated home, preferably via a communication medium such as the Internet, by presenting the user with a visual representation of a house. Initially, the house is generic, that is, shown without any finishing or specific details. The user is presented with the option of selecting a specific element or component of the house from a set of related options. For example, the outside trim of the house may be selected from various styles such as “Stone,” “Western” or “Colonial.” Each outside trim package will include a specific color, fixtures and other components of a common theme. When the user makes a selection, the image of the house is redrawn with the selected option included. For example, the user may elect to add a back room, or a second floor. Each time the user makes a selection, the image is updated to reflect the appearance of the house with the new option. When the user has advanced through all sets of options, the image represents a complete house. Certain selections may lead to another set of options such as various layouts for the added rooms.

This method is simplified for the user as the options are presented as discrete sets of related elements. Thus, the user may concentrate on the selection at hand. If at any time the user wants to change a selection, navigation options within the program will allow the user to change a prior selection without having to reselect the other options.

This method operates in conjunction with the modular product buildings system described in co-filed application, Attorney Docket No. 286357-00004-1, which is incorporated by reference, and which includes the key elements that enable the streamlining and simplification of the entire experience of custom house building and pricing. Through innovative elements large and small the software guides even a novice through a decision making process that will give users homes that fit their needs, aesthetic, lifestyle and budget.

In broad terms this has been achieved by implementation of the following principles:

Making the decision process linear: People are confused when having to make several decisions at once. When several decisions need to be made and are contingent on each other, confusion can arise to the uninitiated in that field. The means to resolve this is to “weight” each decision; that is to say, give each decision a factor of importance 1 through 10 and arrange them in sequence of importance. Once this can be achieved for the entire process, the user can be asked to make decisions one at a time, in sequence minimizing confusion and speeding the process.

Narrowing information to the decision making progress: It is important, however, that only those decisions that the user has made or is about to make are available to view and that decisions yet to be made are shielded from immediate view. Narrowing the information field of view temporarily for the user again helps clarity of thought, and to arrive at a core decision faster.

Allow flexibility in the system: The best way to make decisions is to allow flexibility in the system, i.e. there is always a second chance to make a decision. Throughout the building process there is a built-in ability to be able to go back and make changes.

Visualization: Unlike the prior art, the software updates all images in real time, in 3D, and in many instances are consumer rotatable.

Pricing: In what is a revolutionary way of pricing homes, we have applied an auto leasing analogy to house buying, understanding pricing, pricing the house on a monthly basis rather that a total cost.

### BRIEF DESCRIPTION OF THE DRAWINGS

A full understanding of the invention can be gained from the following description of the preferred embodiments when read in conjunction with the accompanying drawings in which:

FIG. 1 is a flow chart showing the steps of the present method.

FIG. 2 is a schematic view of a computer system.

FIG. 3 is a view of a first page used to implement the method.

FIG. 4 is a view of a second page used to implement the method.

FIG. 5 is a view of a third page used to implement the method.

FIG. 6 is a view of a fourth page used to implement the method.

FIG. 7 is a view of a fifth page used to implement the method.

FIG. 8 is a view of the first page showing an alternate image.

FIG. 9 is a view of a sixth page used to implement the method.

FIG. 10 is a view of the sixth page showing an alternate image.

FIG. 11 is a view of the sixth page showing an alternate image.

FIG. 12 is a view of the sixth page showing an alternate image.

FIG. 13 is a view of the sixth page showing an alternate image.

FIG. 14 is a view of the sixth page showing an alternate image.

FIG. 15 is a view of the sixth page showing an alternate image.

FIG. 16 is a view of the sixth page showing an alternate image.

FIG. 17 is a view of the sixth page showing an alternate image.

FIG. 18 is a view of the sixth page showing an alternate image.

FIG. 19 is a view of the sixth page showing an alternate image.

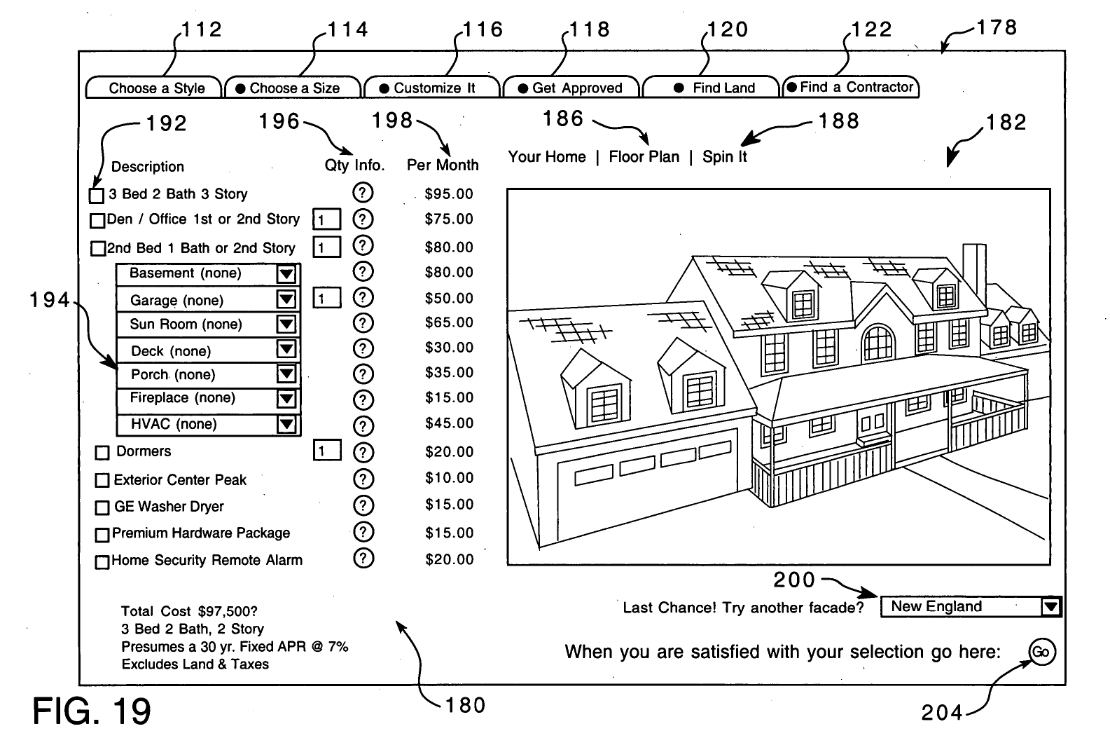

FIG. 20 is a view of a seventh page used to implement the method.

FIG. 21 is a view of an eighth page used to implement the method.

FIG. 22 is a view of a ninth page used to implement the method.

FIG. 23 is a view of a tenth page used to implement the method.

FIG. 23A is a view of an eleventh page used to implement the method.

FIG. 24 is a view of a twelfth page used to implement the method.

FIG. 25 is a view of a thirteenth page used to implement the method.

FIG. 26 is a view of a fourteenth page used to implement the method.

FIG. 27 is a view of a fifteenth page used to implement the method.

### DESCRIPTION OF THE PREFERRED EMBODIMENTS

As used herein, a “computer” includes devices associated with a computer which are coupled to a CPU, such as keyboards and mice, displays or other components for interacting with humans, as well as computers such as a server which is typically accessed from a remote location.

As used herein, a “program” includes, but is not limited to, a computer program or a group of interacting programs used by a processor and stored on a medium such as a hard drive, CD, DVD, or in an integrated circuit such as an EPROM.

As used herein an “electronic communication network” includes any system of linked computers such as the Internet, an Intranet, or a school or company network.

As used herein a “computer readable medium” includes, but is not limited to, hard drives, CDs, DVDs, magnetic tape, floppy drives, and random access memory.

As used herein a “computer file” is an electronic storage means for containing data that may be expressed as text, images, audio, video or any combination thereof.

As used herein, a “page” means a static or interactive HTML screen that is displayed on a computer monitor.

As used herein, to “select” or to “click on” an option on a page means to use an input device, such as a mouse, to communicate to the computer which option on the page is chosen.

As used herein, a “button” on a page is an area of the image that may be selected or clicked on to cause the program to provide additional data or display a new page.

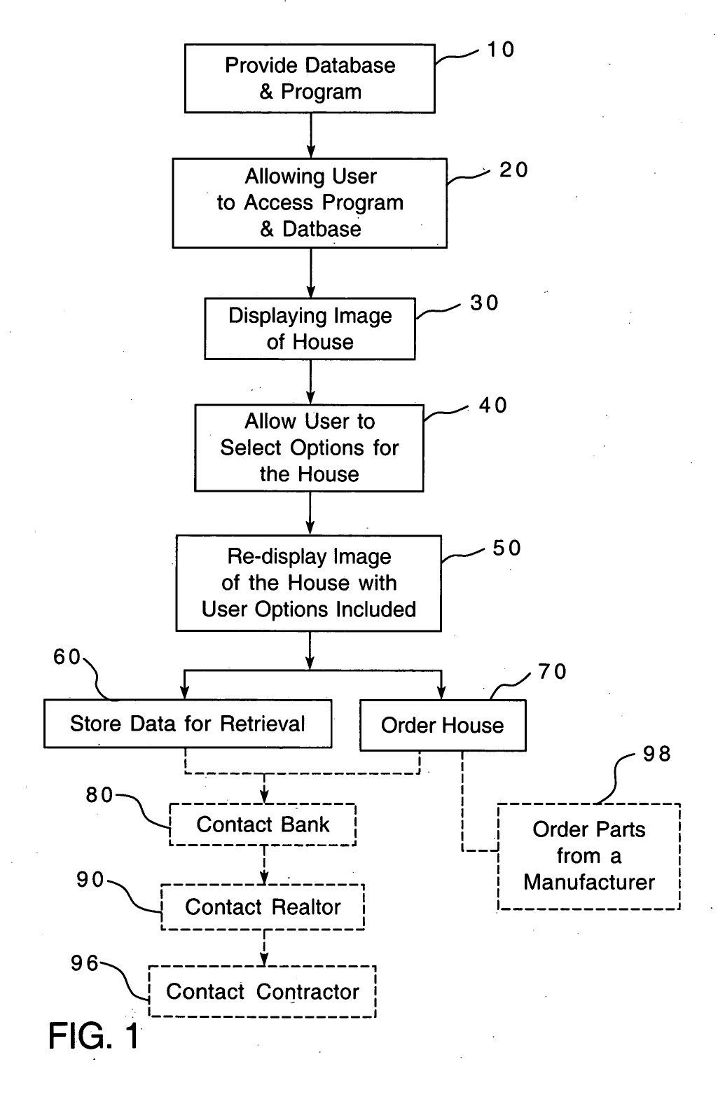

As shown on FIG. 1, the method of selling custom prefabricated houses includes the steps of providing a computer database 10 which includes data representing price charts and images, the price data and images representing various components of the prefabricated house, allowing a user to access the database 20 via a computer and a communications medium, displaying an image of a prefabricated house 30 as well as an associated price and a means to allow the user to select options to the house, allowing the user to select optional components to the house 40, re-displaying an image of the house with the user selected options included in the image 50, as well as displaying a price associated with the house with user selected options, and allowing the user to store the user selection for later retrieval 60 or ordering the house 70. There are the further optional steps of allowing the user to contact a mortgagor or bank 80, allowing the user to contact a realtor 90, and allowing the user to contact a contractor 96.

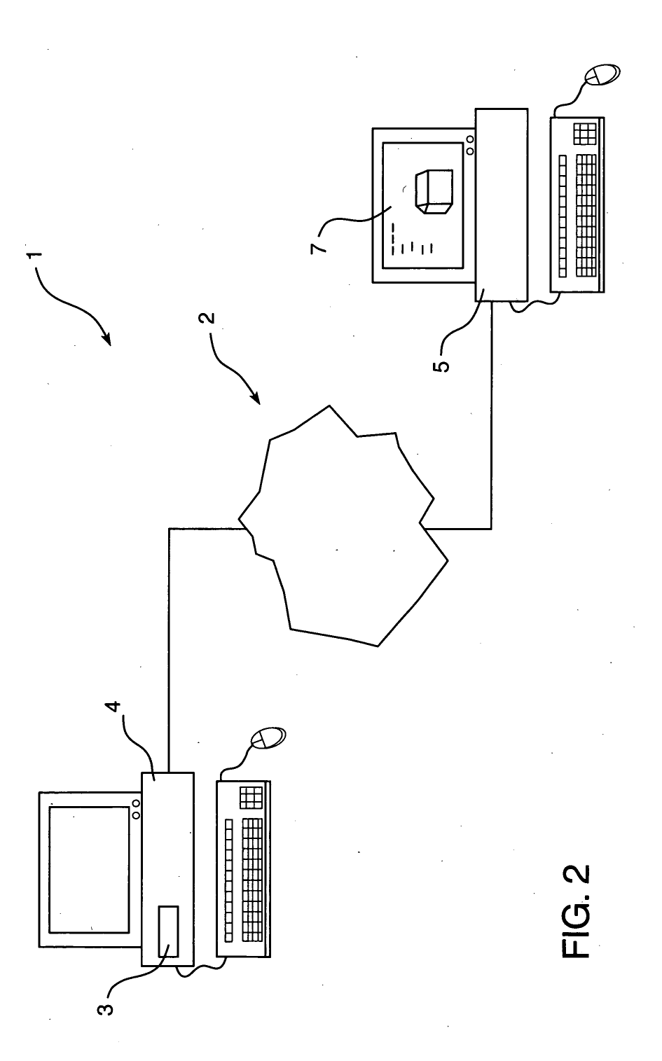

The method is preferably implemented by a computer program that generates an Internet web page or site. Thus, as shown on FIG. 2, a computer system 1 utilizes an electronic communication network 2 that is structured to allow communication between a user and a computer program 3. The computer program 3 is operational on a server 4 or remote computer. The computer program 3 and data contained in a database is controlled by a service provider. That is, the service provider selects what types and style of homes will be sold. The service provider may also be affiliated with third parties, such as realtors and contractors. The user has a first computer 5 which is coupled by a modem (not shown) or other communication device to the electronic communication network 2. The user may access the program 3 via the communication network 2 so that the program 3 may receive input from the user and transmit visual and audio indicia to the user. That is, the program 3 is structured to create web page images 7 and/or sounds on the user's computer 5. The user may input information into the first computer 5 via input devices such as a mouse or keyboard. As an alternative to using a remote server 4, the program 3 and data may be contained on a stand alone computer 8, such as a computer 8 in a dealer's showroom.

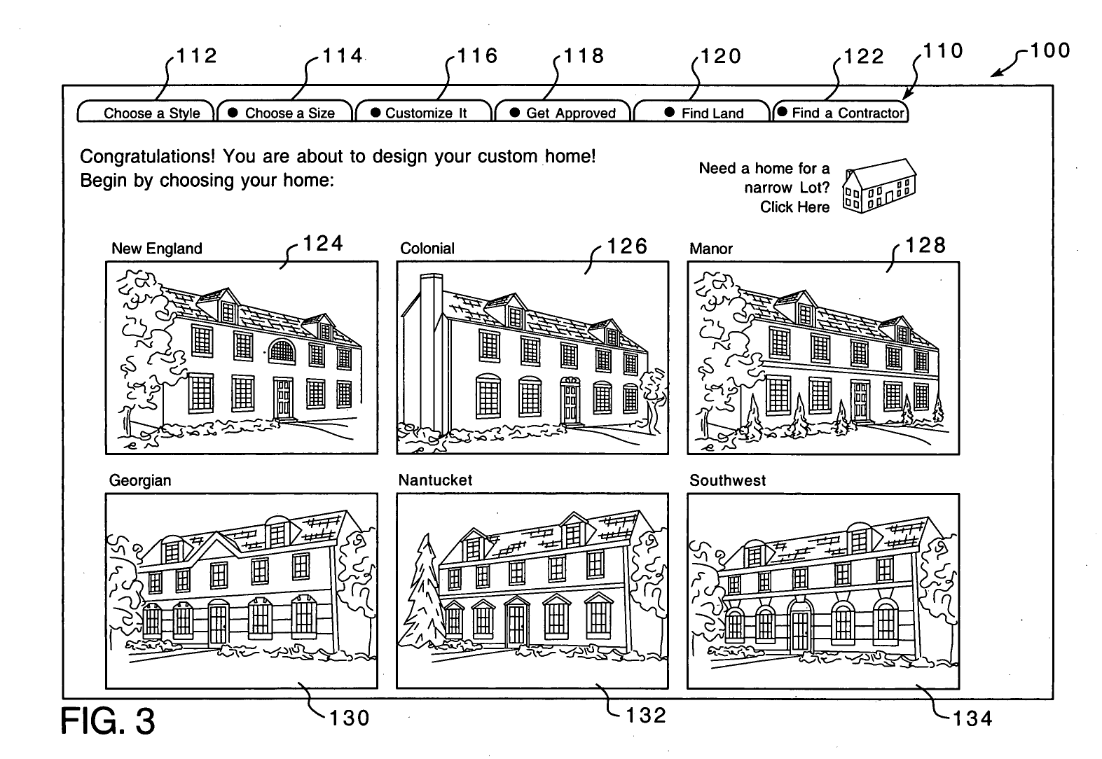

When the user accesses the remote server 4 via the communications network 2, the program 3 allows the user access the database 20 and displays a first web page 100 having six tab-like buttons 110 as shown in FIG. 3. As the user builds their house, they essentially move from the left-hand tabs 112, 114, 116, toward the right-hand tabs 118, 120, 122 as will be evident. These tabs 112, 114, 116, 118, 120, 122 remain visible on all pages, unless the program 3 directs the user to a third party site, thereby allowing the user to easily navigate the site and change any selected feature of the house. Each tab is a step in the home design sequence. For example, the first tab 112, identified with the words, “Choose a Style,” allows the user to select one of various styles of homes, e.g., New England, Colonial, etc. The second tab 114, identified with the words “Choose a Size,” allows the user to choose a size, typically represented by a total number of square feet. The third tab 116, identified with the words “Customize It,” allows the user to add user features. The fourth tab 118, identified with the words “Get Approved,” provides a link to a loan application or to a third party bank. The fifth tab 120, identified with the words “Find Land,” allows the user to contact a realtor and may provide a list of available land. The last, sixth tab 122, identified as “Find a Contractor,” allows the user to contact a contractor.

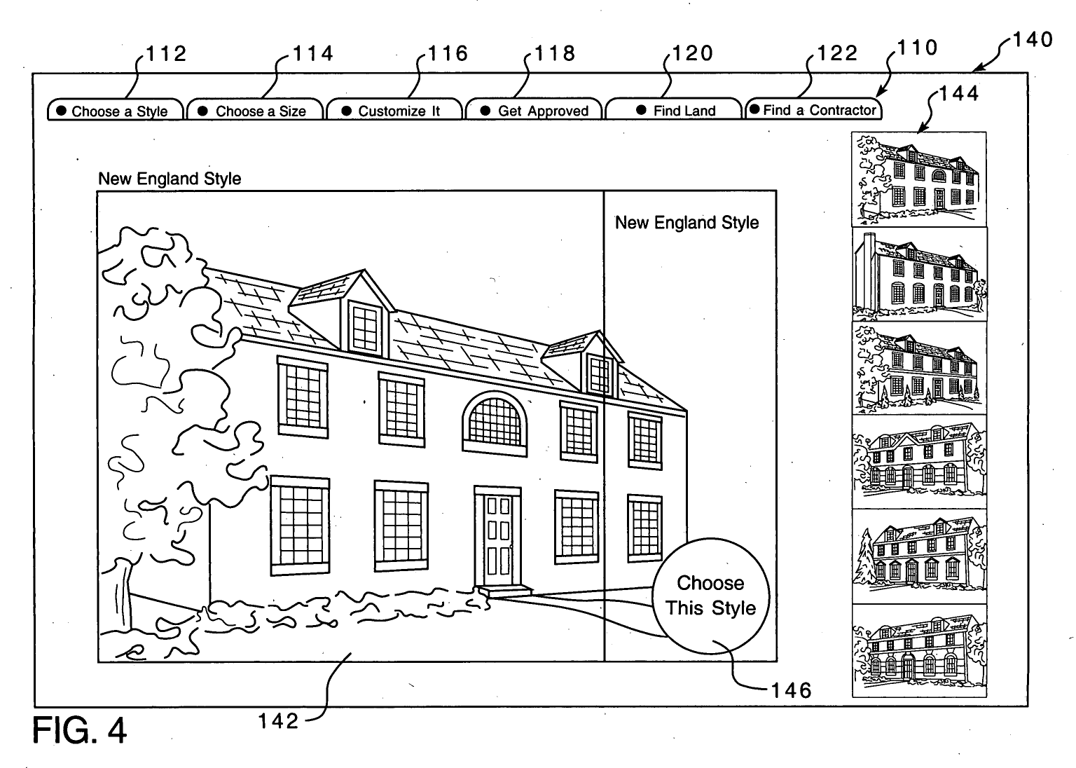

As part of the initial step of displaying an image of a prefabricated house 30, as well as an associated price, when the user initially accesses the site, the first page 100, which is associated with the first tab, 112 “Choose a Style,” is displayed. The first page 100 includes a display of multiple images showing various styles of homes. As shown, there are six images 124, 126, 128, 130, 132, 134, each image showing a different style of home. As house buying is as much an emotional decision as a financial one the user is simply asked to choose a style they like. All the homes are shown as being the same size. Thus, the user is able to focus better on a pure style decision. Additionally, the program 3 produces a button (not shown) that says “Choose This Style” whenever a user moves the mouse over of each image. When the user selects a style, the program 3 provides the page shown in FIG. 4.

As a continuation of the step of displaying an image of a prefabricated house 30, and as shown in FIG. 4, after the user has made a selection from the initial images 124, 126, 128, 130, 132, 134, the program presents a second page 140 that includes a larger image 142 of the selected home, with the rest of the selections presented as thumbnails 144 but still present to the user. The larger image 142 affords more space for descriptive copy and the user may explore the other styles and descriptions by selecting one of the thumbnails 144. When a user selects a thumbnail 144, the image in the thumbnail 144 switches place with the larger image 142. Purposefully, therefore, the first and second web pages 100, 140, essentially, perform the same function, but, by virtue of the fact the images 124, 126, 128, 130, 132, 134 are constantly displayed, the user has more time to review their options and settle on a style. The user may then select a desired style by clicking on the “Choose This Style” button 146. When the user makes a final selection on a page, the program 3 advances to the page associated with the next tab, in this case the second tab 1 4, “Choose a Size.”

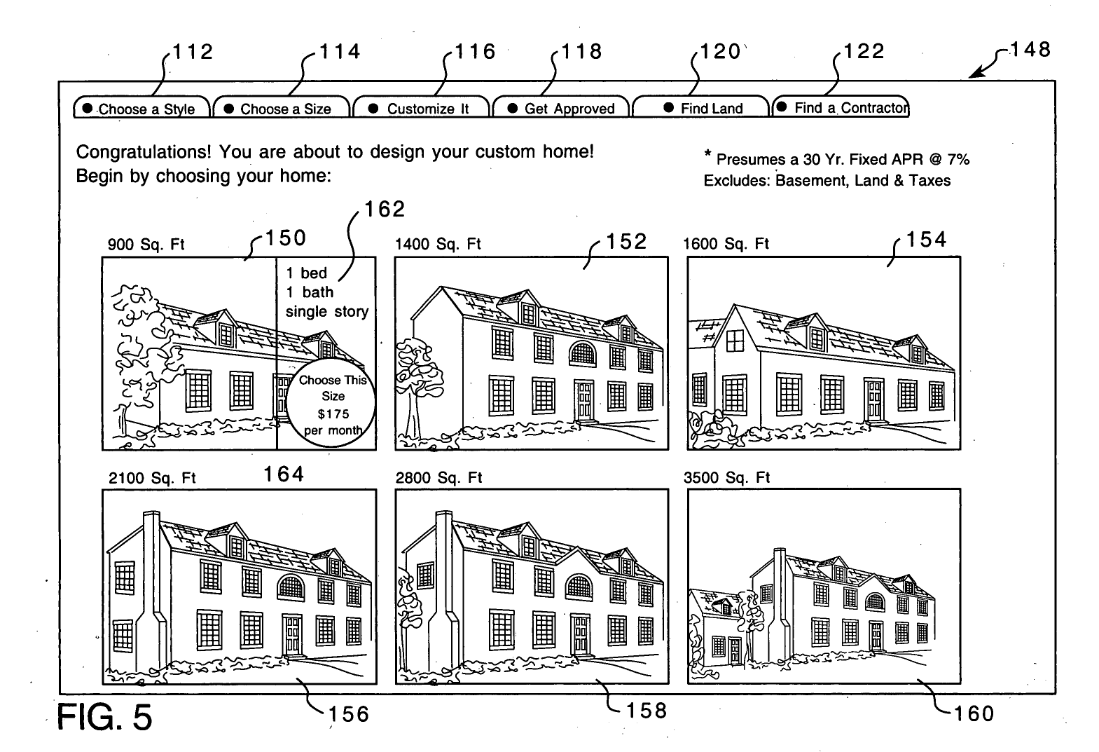

As an initial portion of the step of allowing the user to select optional components to the house 40, once the user has selected a style, and as shown in FIG. 5, the program 3 presents a third page 148 that allows the user to choose the approximate size/price of their home. Again, information is pared down to the bare minimum and presented sequentially to the buyer to enable them to make a better decision. Thus, a second series of images 150, 152, 154, 156, 158, 160 is presented. Each image 150, 152, 154, 156, 158, 160 shows a home having the style selected by the user on the second page 140, but each image shows the style on a house of a different size. For example: size is defined as square footage and number of beds and baths, information that is displayed on an overlay 162 to specific image 150, 152, 154, 156, 158, 160. Mousing over an image 150, 152, 154, 156, 158, 160 reveals the overlay 162. The overlay 162 may also display a price for the selected image 164. Money is described as monthly payment, because, ultimately, a monthly payment is what matters to most users. The program 3 calculates the monthly payment based on a 30-year fixed monthly annual percentage rate and linked on-line to that day's present interest rate on a mortgage, presumes the applicant has good credit and applicant will provide a modest down payment. These presumptions are made to stream the prices and part of the “roughing out”. All details are fine-tuned downstream.

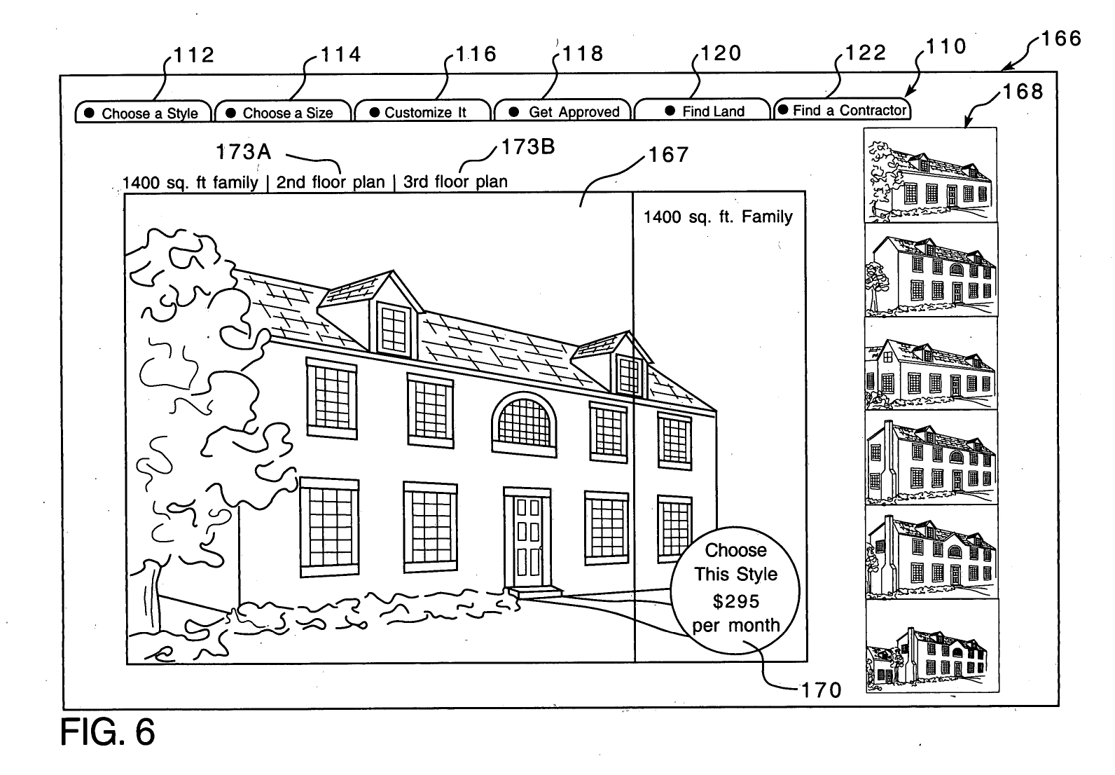

After the user makes an initial selection, the program 3 displays a fourth page 166, shown in FIG. 6. Similar to the relationship between the first and second pages, 100, 140, the program 3 provides explanation, validation and the opportunity to compare and the ability for the user to change their mind. That is, the program 3 displays the user's selection as a larger image 167 with comparative thumbnails 168 of the rejected models on the right. The user is free to peruse through the thumbnails 168 and clicking on the thumbnails 168 swaps the thumbnail 168 with the larger image 167. Mousing over the larger image 167 provides a second overlay 170 with a more detailed description of the home. That is, when the mouse is placed over the large image 167, the price is re-stated, with an asterisk (not shown) to a notation about the terms and annual percentage rate (not shown). The user then selects a size by clicking on the “Choose This Size” button 171.

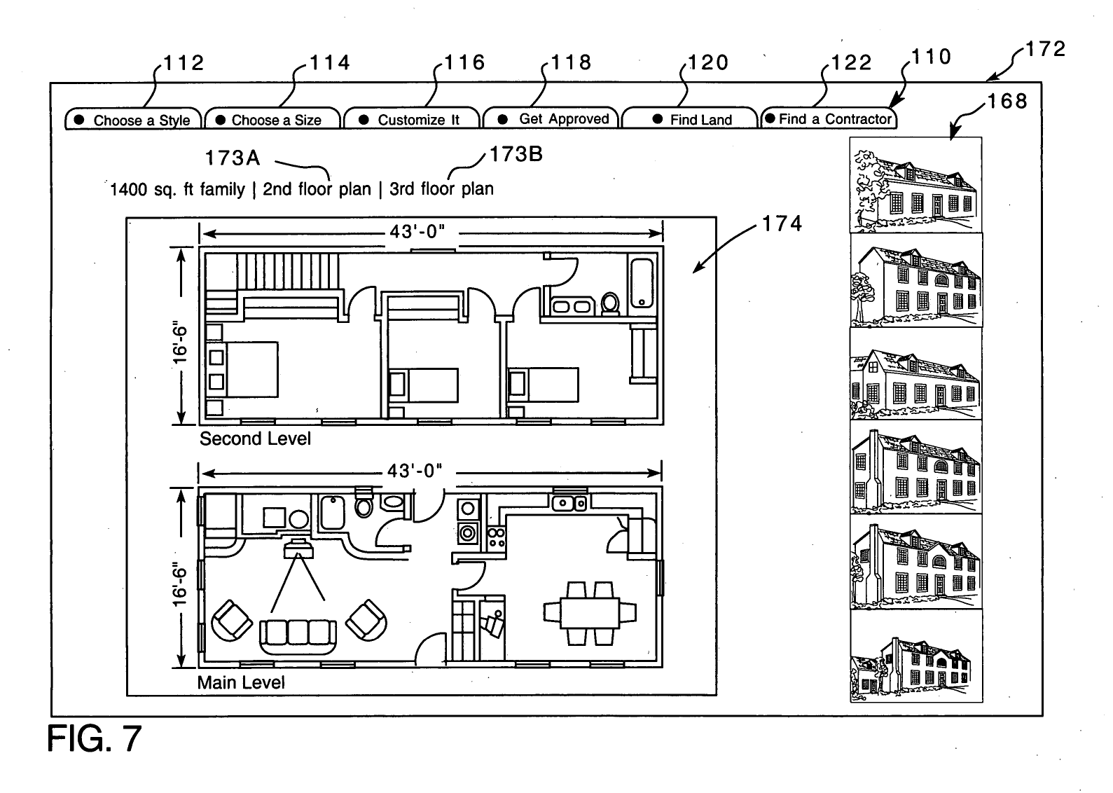

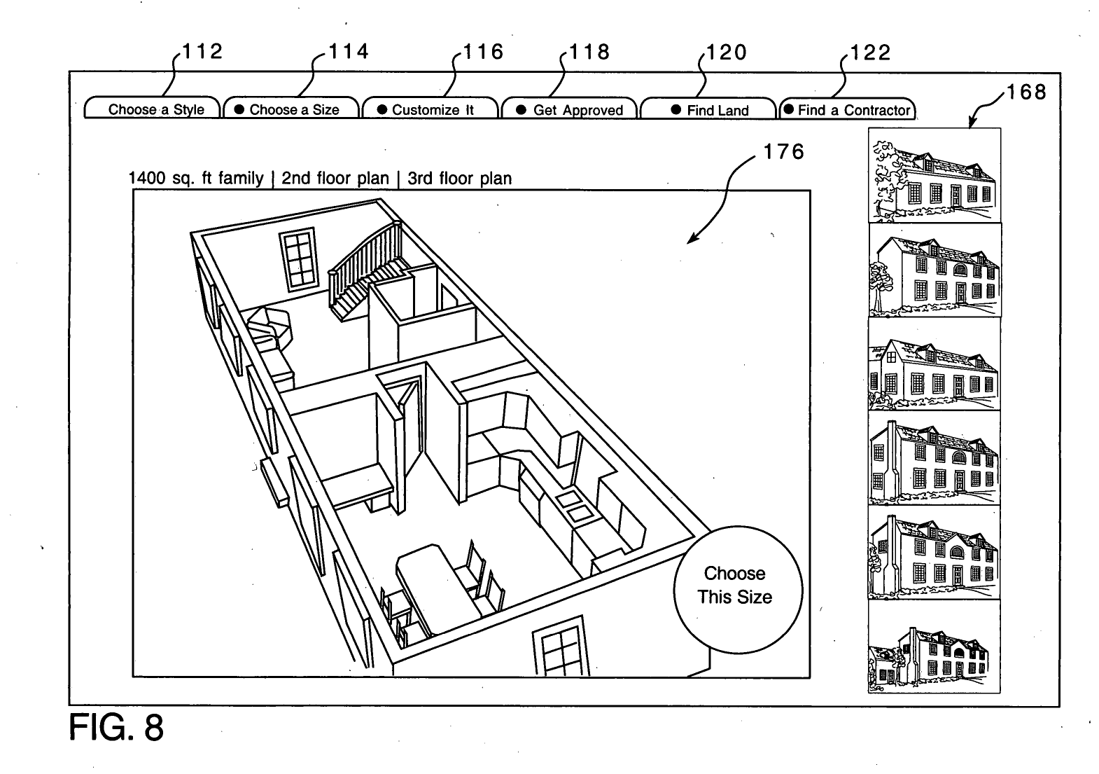

Once a size has been selected, the program allows the user to access a fifth page 172, shown in FIG. 7. On the fifth page 172, the user is introduced to floor plans via a first, two-dimensional floor plan tab 173A, and a second, “three-dimensional” floor plan tab 173B located above the large image 167. To access the fifth page 172, the user selects the first, “two-dimensional” floor plan tab 173A, or the second, “three-dimensional” floor plan tab 173B. Once a tab, for example, the first floor plan tab 173A is selected, the large image 167 is converted into a two-dimensional image 174, i.e. floor plan, of the home. Similarly, if the second floor plan tab 173B is selected, and as shown on FIG. 8, the large image 167, or the “two-dimensional” floor plan image 173A, is converted into a three-dimensional image 176 of a floor plan. These floor plan images 174, 176 allow the user to accurately ascertain whether the physical space meets their requirements.

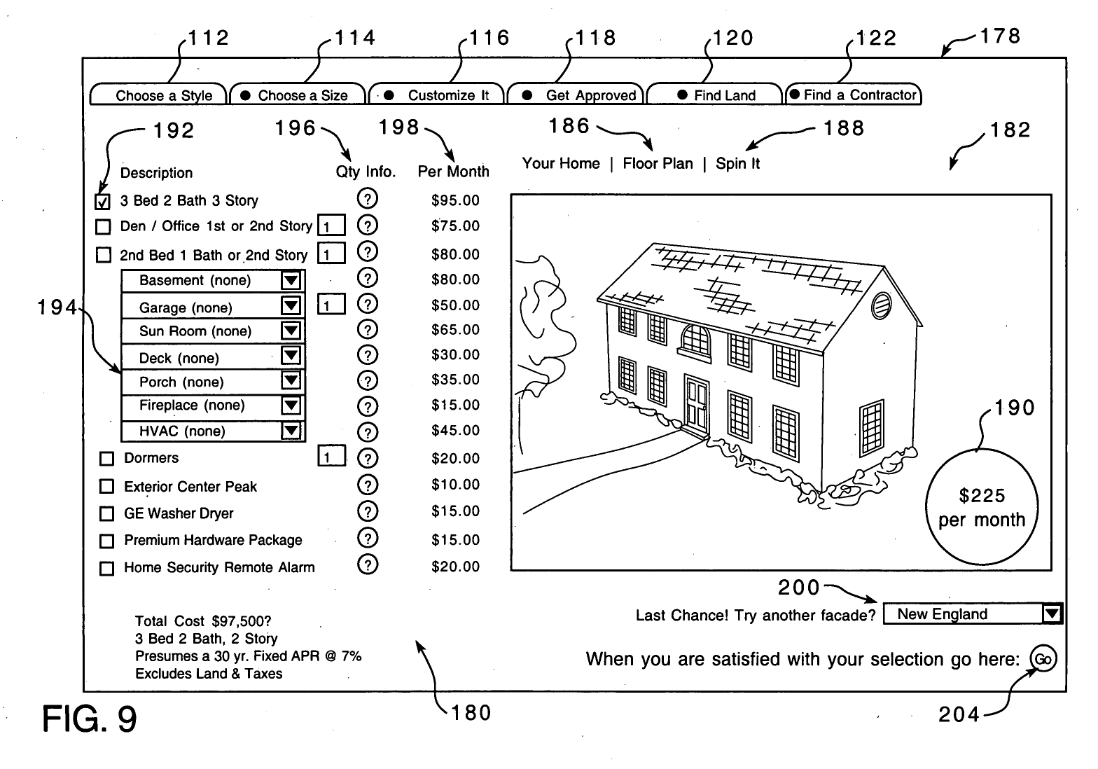

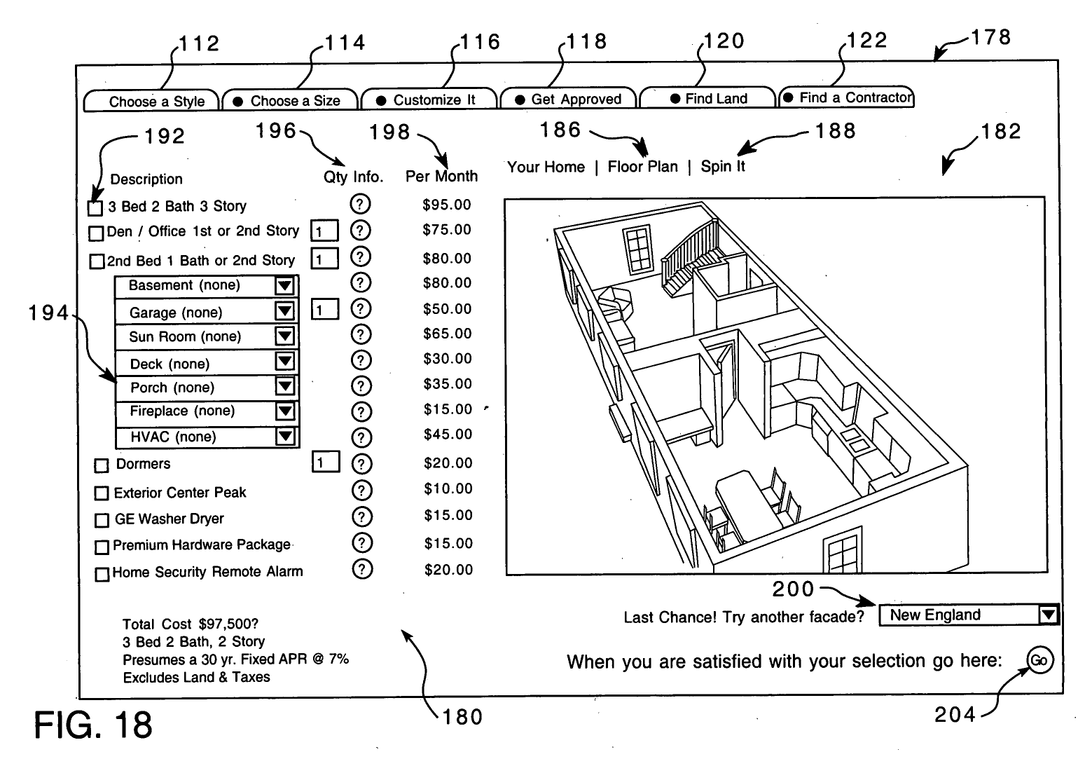

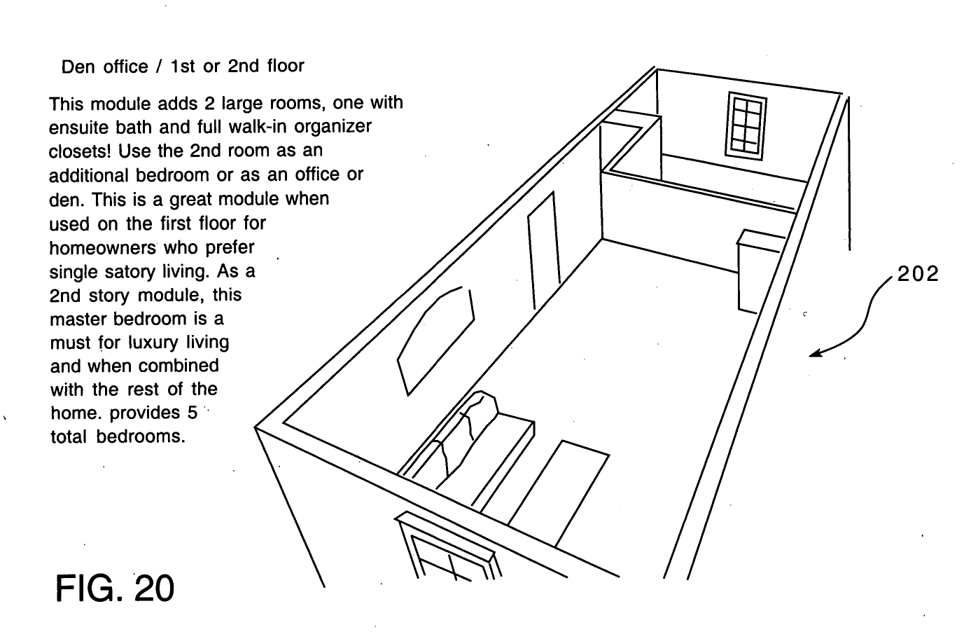

Once the user has made a final selection as to size, the program 3 displays a sixth page 178. The sixth web page 178 is also displayed if the third tab 116 is selected. This portion of the program 3 further facilitates the step of allowing the user to select optional components to the house 40 as shown in FIGS. 9-17. The options presented by the program 3 are compacted into a single frame 180. This frame 180 allows the user to make many complicated interrelated decisions in an expedient understandable manner. Within the frame 180 are a plurality of options 184, described below. As shown in FIGS. 9-17, the sixth page 178 includes an oversize image window 182. The image window 182 updates in real-time any time an option 184 is selected. The options 184 are additional elements and components that may be incorporated into the house. The options 184 are broken down into types. Reading from the left these options are: 1) check boxes 192, wherein the user checks box and the frame updates with the item described; 2) drop down boxes 194, wherein the user is presented with a selection of similar options, for example, there may be several styles of garages available; 3) the third row is a descriptor button 196, opening a new window with a description of that specific item, see FIG. 20 for an example; and 4) a price list 198 for each option wherein the price is based on a monthly basis with the same formula described above. That is, that day's average 30-year fixed annual percentage rate mortgage which is used to automatically generate a price for that particular item or package. Additionally, the sixth page 178 further includes a first, “Floor Plan” button 186 and a second, “Spin It” button 188. As shown in FIG. 18, if the user selects the first, “Floor Plan” button 186, the image is converted to a “3d” floor plan, similar to the view associated with the second, “three-dimensional” floor plan tab 173B described above. If the user selects the second, “Spin It” button 188, the image will rotate within the image window 182 and the rotation may be controlled with the mouse.

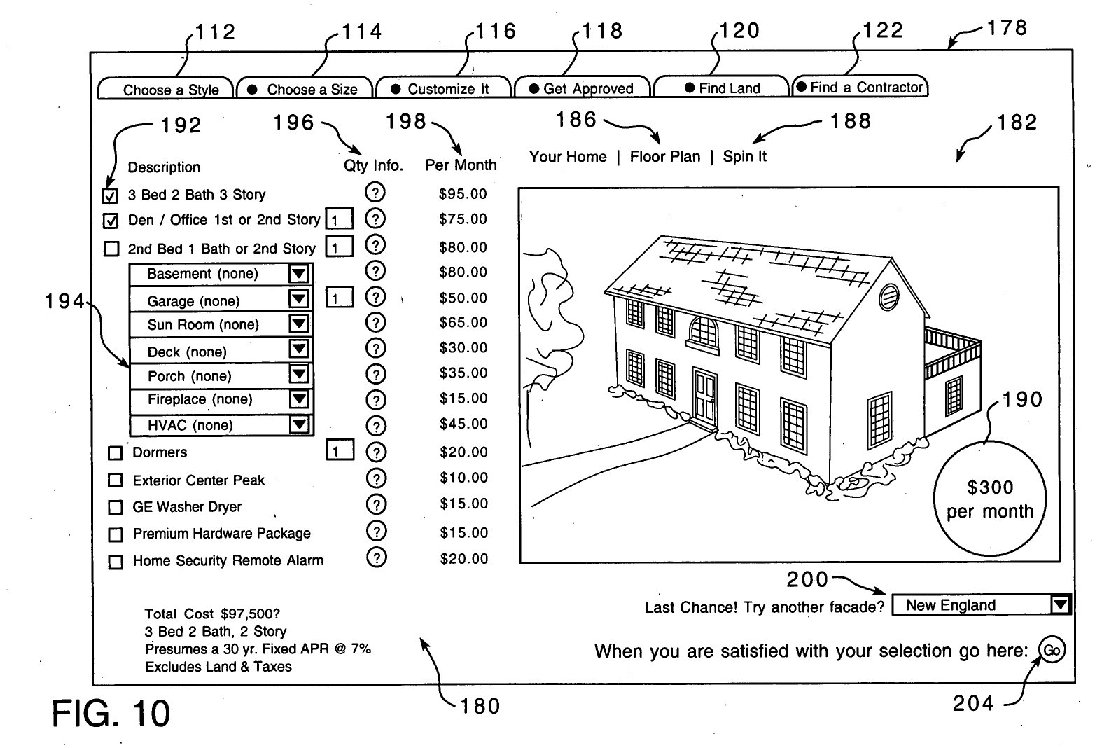

The image window 182 of the sixth page 178 is interactive. That is, the program 3 updates the image within the image window 182 each time the user selects and option from the plurality of options 184. Thus, this portion of the program accomplishes the step of re-displaying an image of the house with the user selected options included in the image 50. In the following description, the house will be continuously enlarged, however, it is understood that a user may also de-select an option and the image would be updated accordingly. Initially, the image, as shown in FIG. 9, is the same as the image selected after the user has selected a size, as shown, the initial selection was a 1400 sq. ft. New England style home with a 3-bed second story. Accordingly, the three-bed second story box is already checked. If the user selects the check box to add a den, the image is re-displayed as shown on FIG. 10. In addition to the image being updated, an estimated price display 190 is also updated so that the user is continuously aware of the projected cost on the model being displayed.

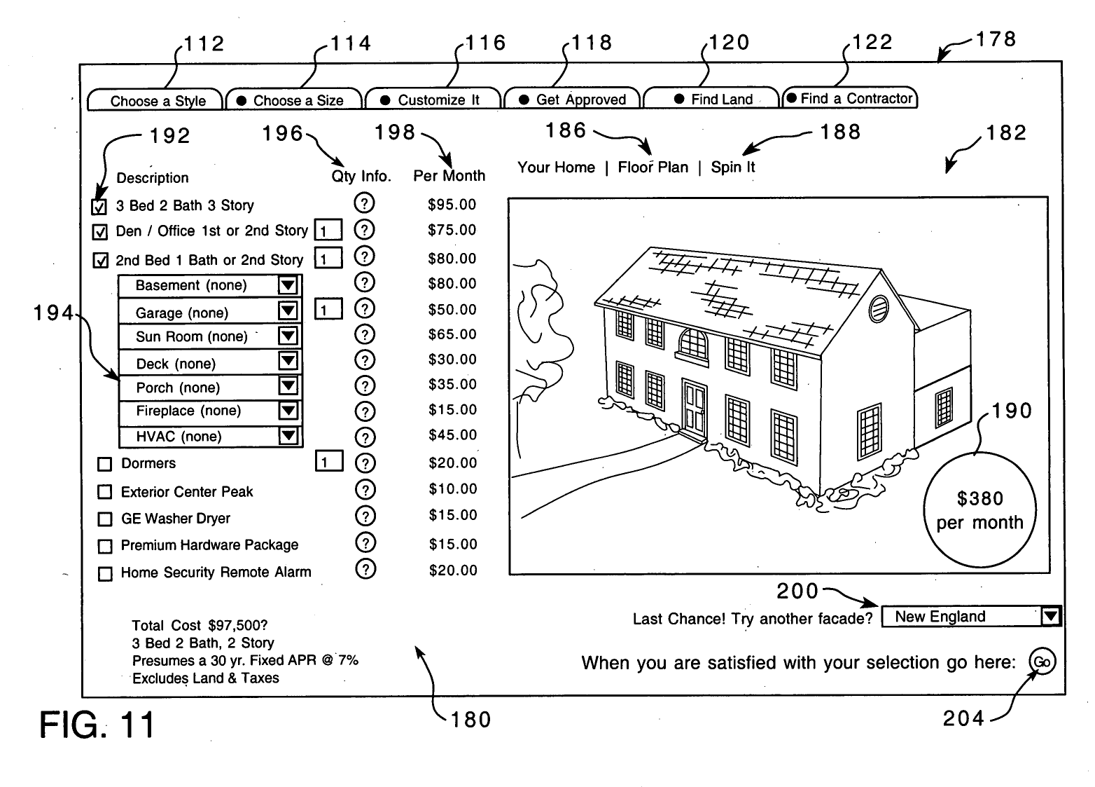

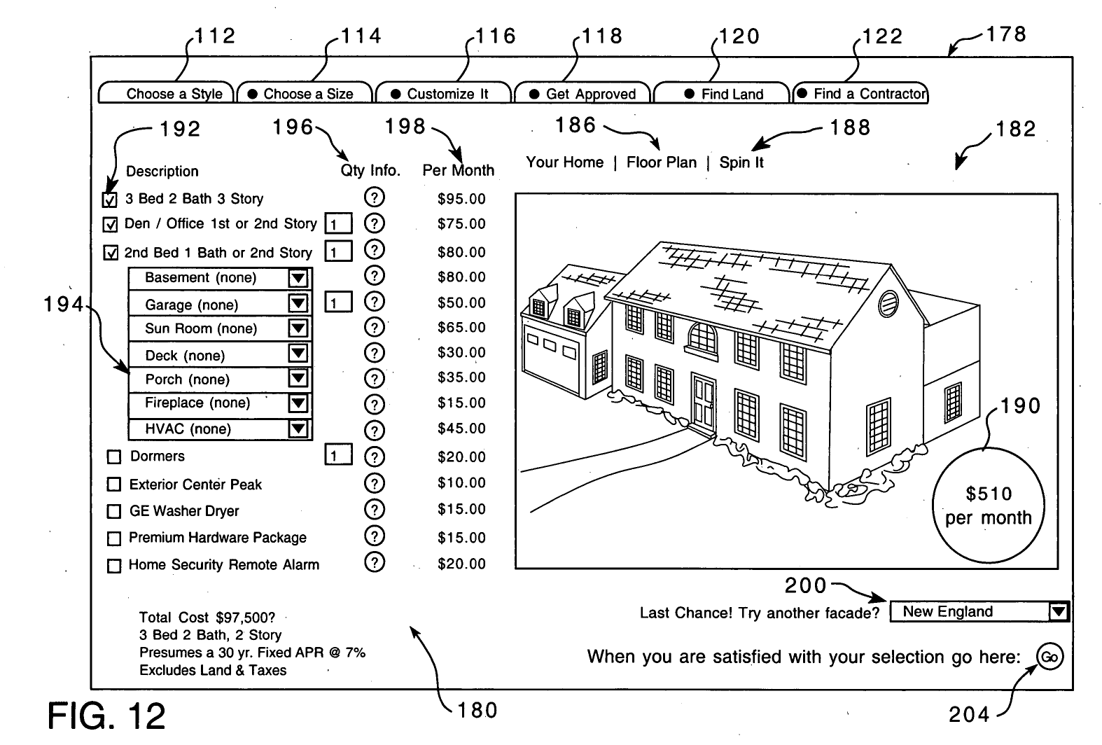

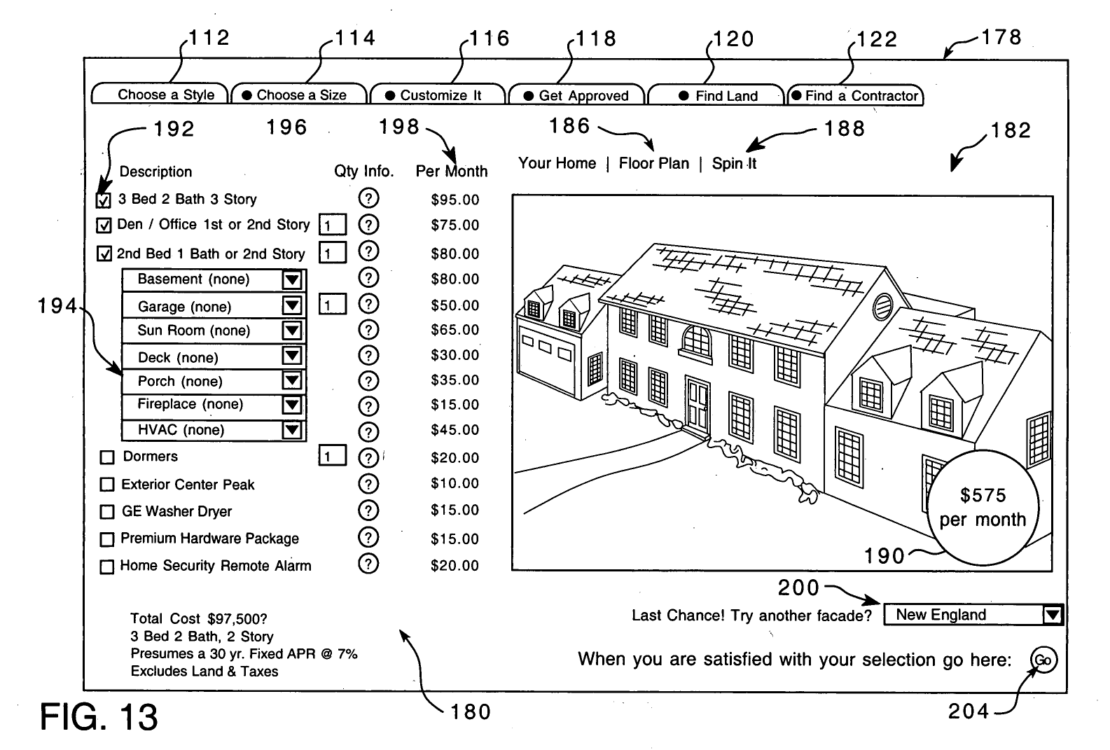

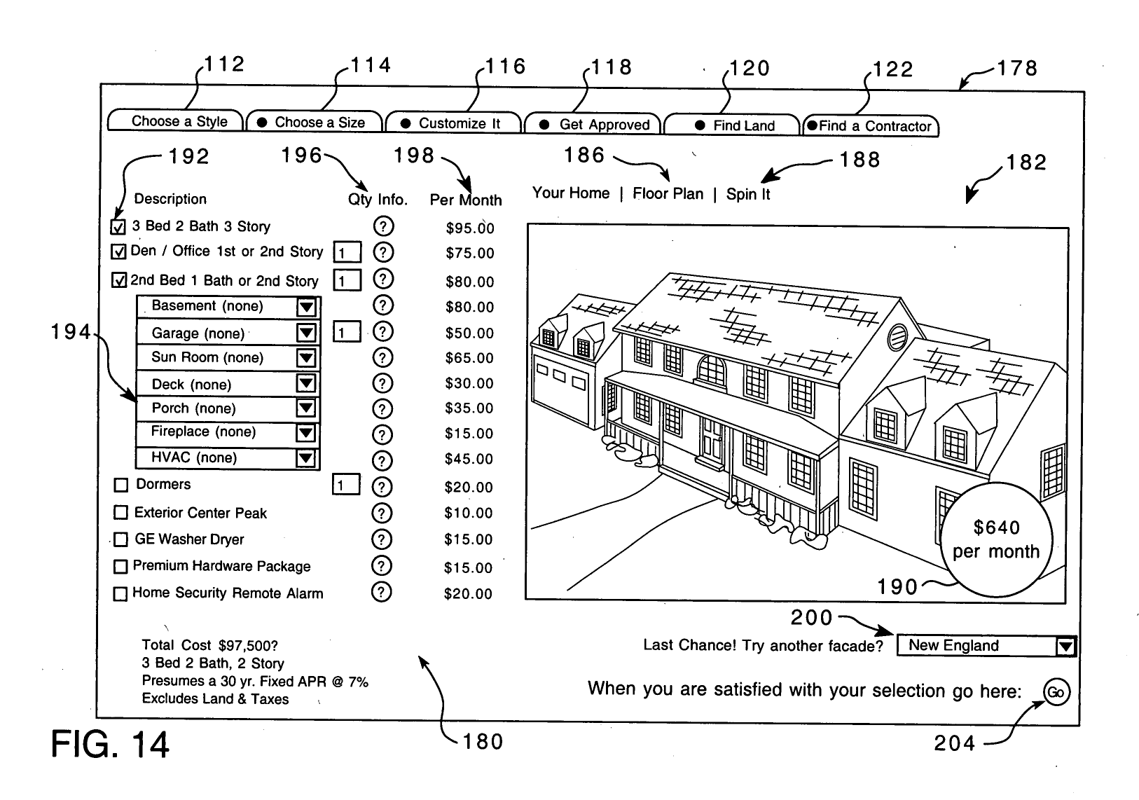

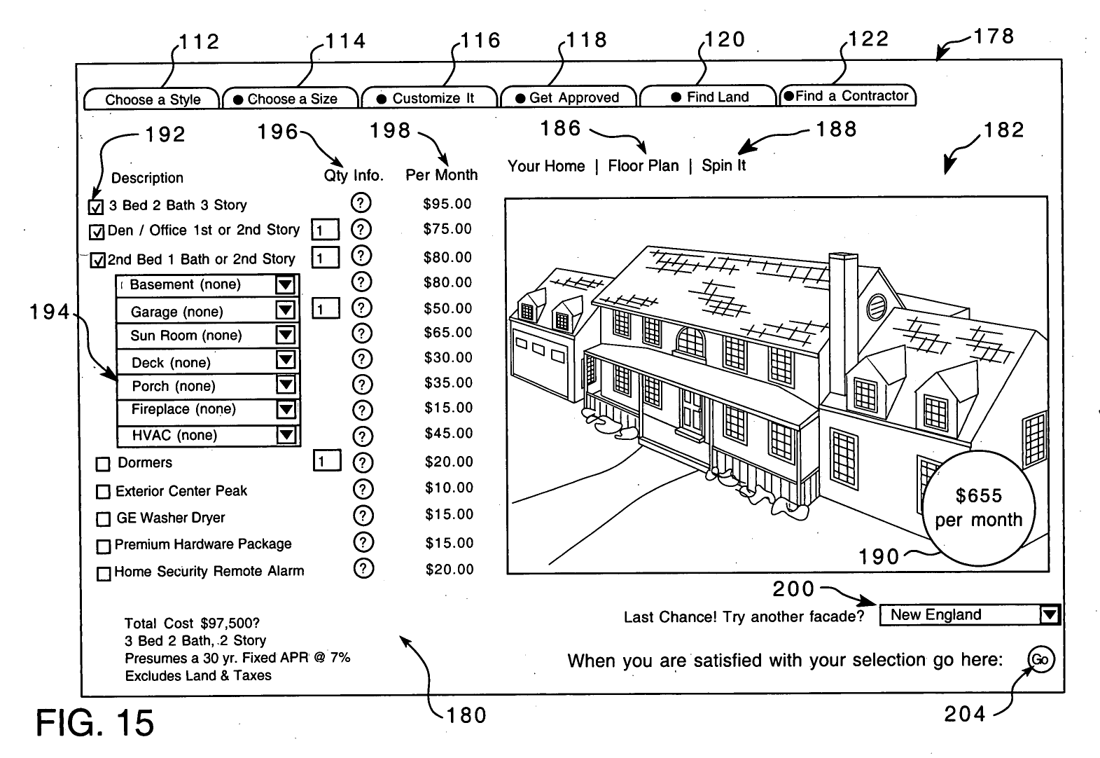

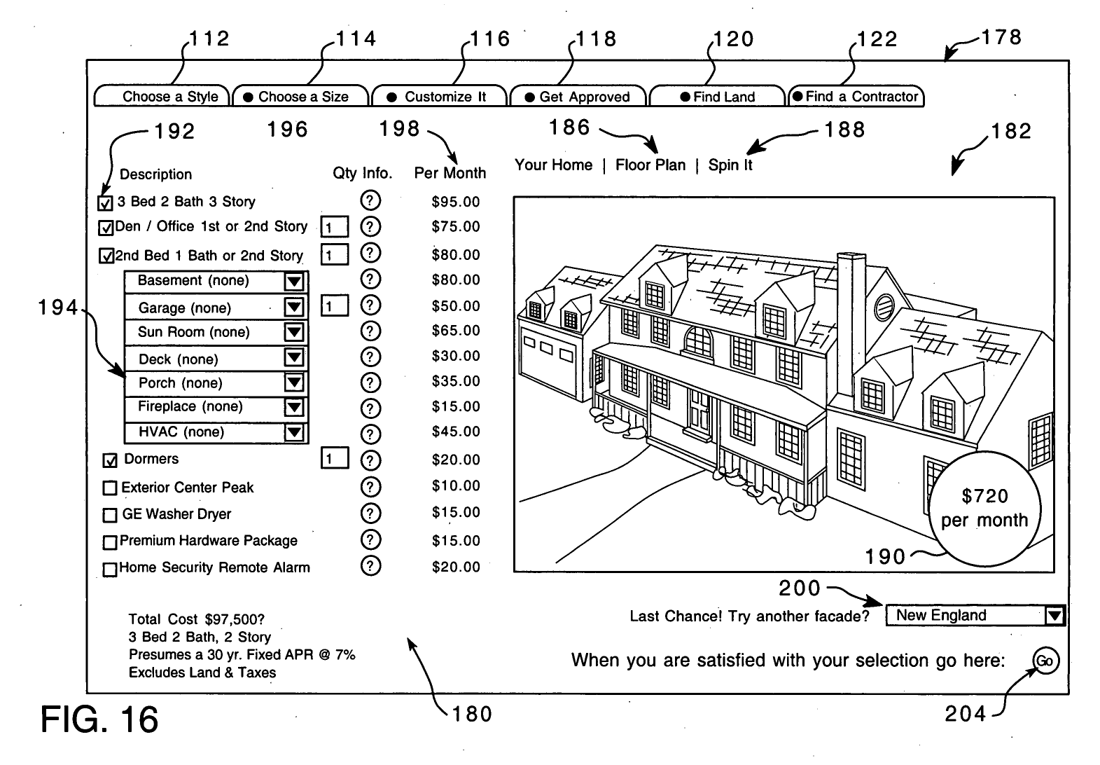

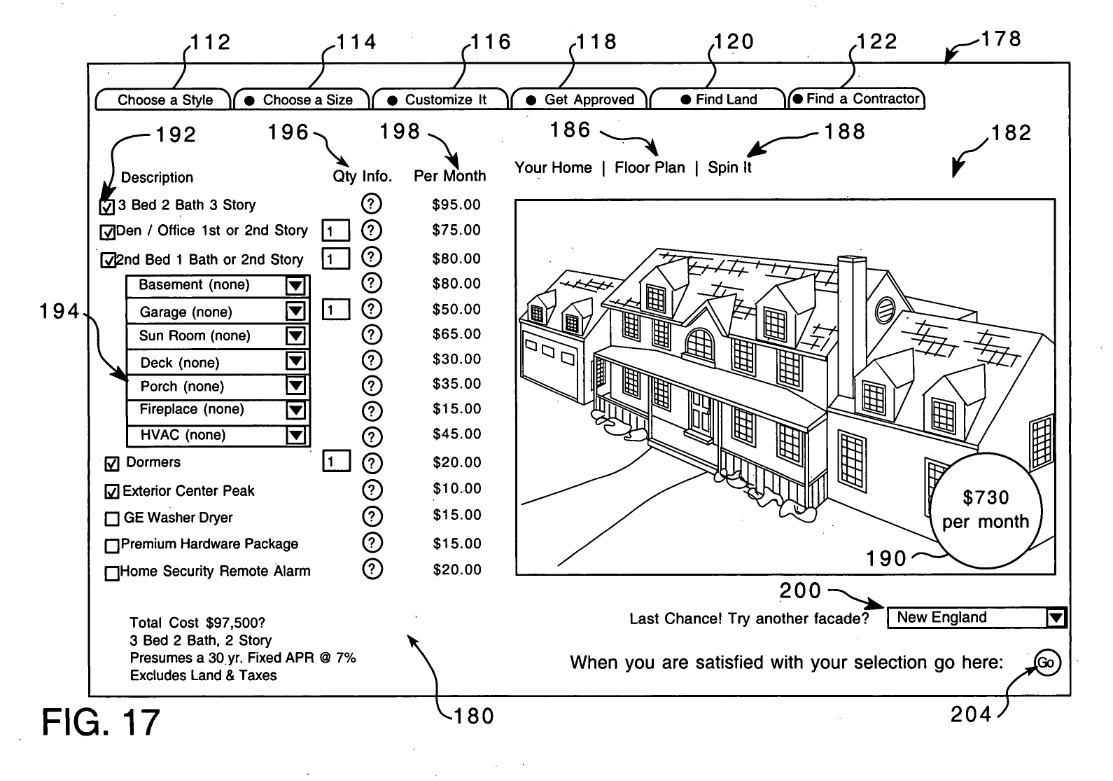

Further additions to the display selected either by checking the associated check box 192 or by selecting the option from a drop down box 194 are shown as follows: In FIG. 11, a second story bed/bath has been added; in FIG. 12, a single wing garage, with dormer, has been added; in FIG. 13, a double wing has been added; in FIG. 14, a deck has been added; in FIG. 15, a fireplace has been added; in FIG. 16, dormers have been added; in FIG. 17, a center peak has been added to the roof. Again, the program updates, or re-displays, the oversize image window 182 each time an option is selected. Finally, the user, once they have finished making their selections, yet again have a chance via a drop down menu 200 to change the entire facade to a house style of their choosing.

Another option the user may select is the descriptor button 196. Each descriptor button 196 is associated with another option, e.g. the den option. When the descriptor button 196 is selected, the program 3 opens a seventh page 202 with a description of the associated option, as shown in FIG. 20. The user may return to the prior, sixth page 178 by using the “back” button on the browser program.

On the sixth page 178, after the user has completed adding all options, reviewing floor plans, and examining the view of the house, the user may complete the process by selecting the “Go” button 204 that is displayed by the message, “When you are satisfied with your selection go here.” When the user selects the “Go” button 204, the program displays the eighth page 210.

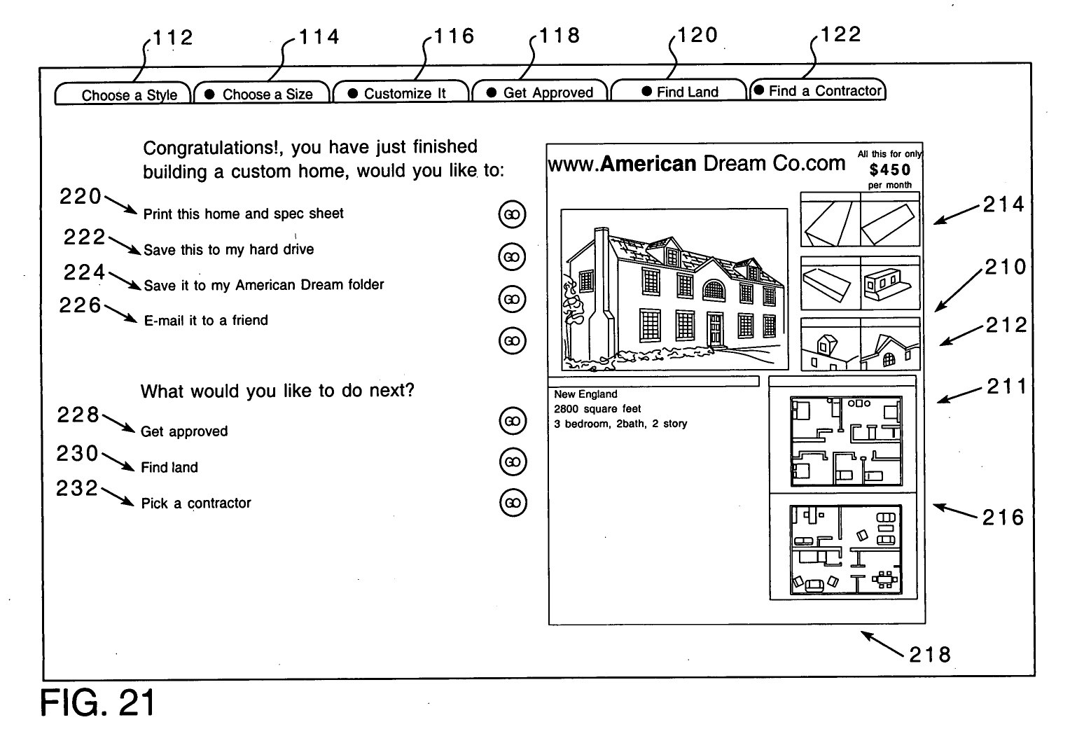

As shown in FIG. 21, the eighth page 211 includes a composite image 210 showing both exterior views 212, interior views 214, floor plans 216, and a description 218. The user is presented with selections to print 220, save to the local computer 222, save to the remote computer 224, or e-mail the design to another 226. The program allows the user to select buttons corresponding to the fourth, fifth and sixth tabs 118, 120, 122. The fourth, fifth and sixth tabs 118, 120, 122 further correspond to the optional steps of allowing the user to contact a mortgagor or bank 80, allowing the user to contact a realtor 90, and allowing the user to contact a contractor 96. That is, the program 3 provides a “Get Approved” button 228 that allows the user to find a loan, a “Find Land” button 230 that links the user to third party realtors, and a “Find a Contractor” button 232, that allows the user to contact contractors.

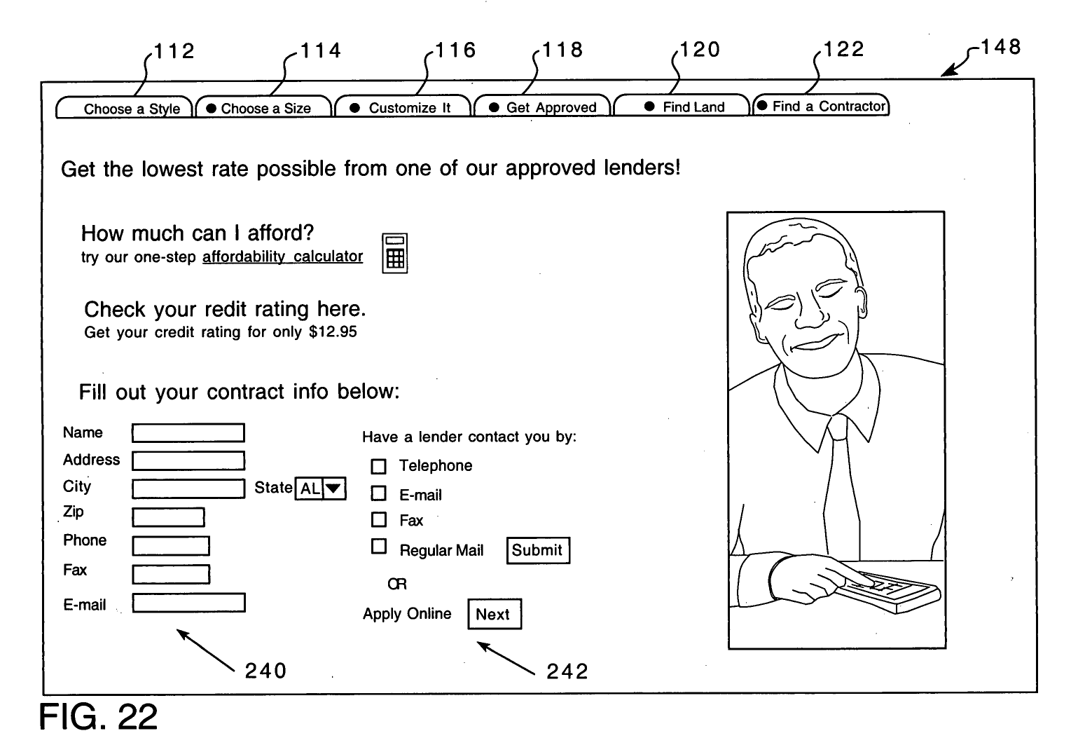

If the user desires to apply for a loan, the user selects either the “Get Approved” button 128, or the fourth tab 118, and the program 3 displays a ninth page 138 that is an initial loan application screen, as shown in FIG. 22. The program 3 collects certain basic information 240 and displays a link 242 to approved lenders who are familiar with the product building system.

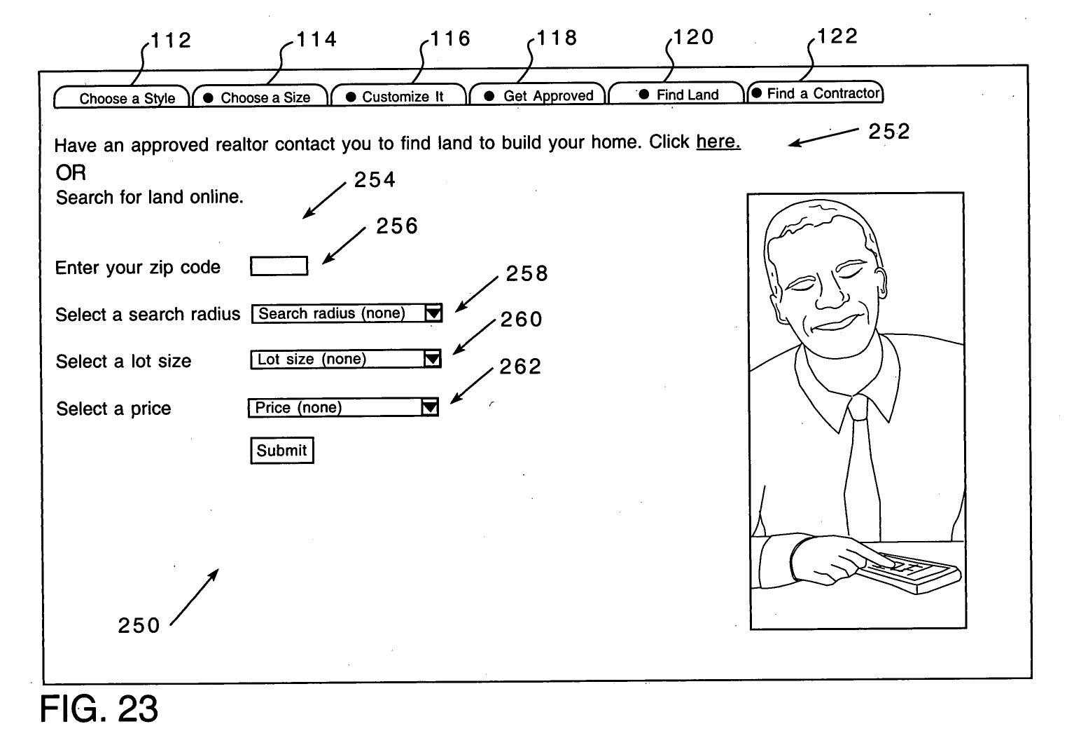

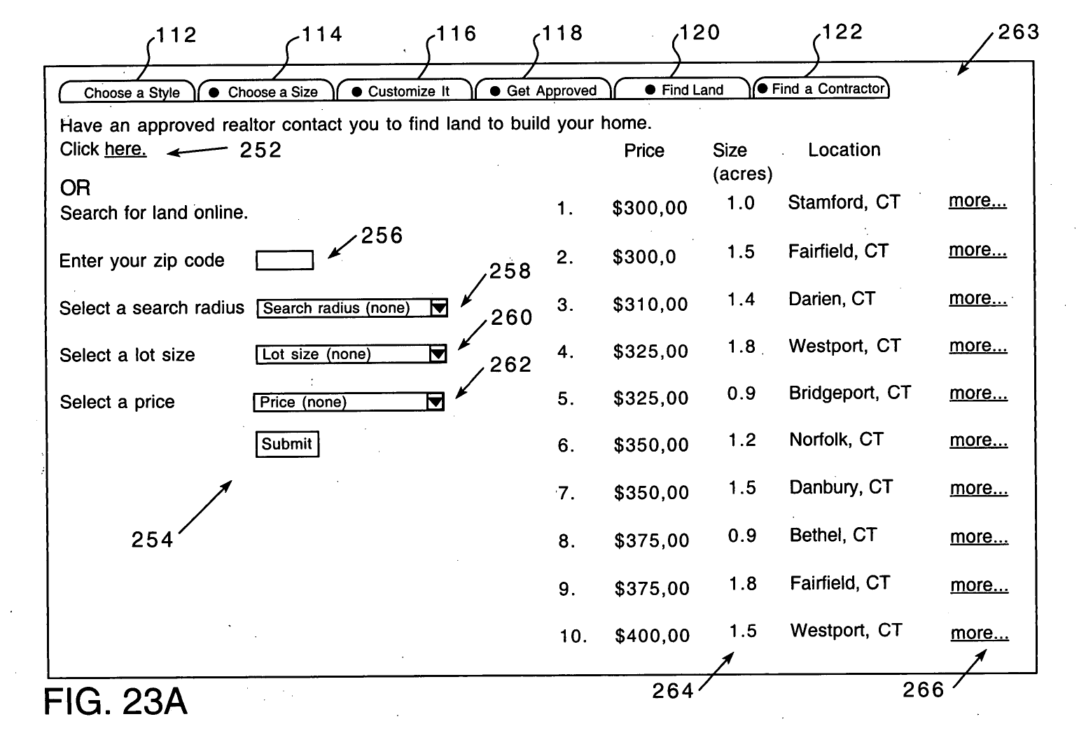

If the user desires to purchase land, the user may select the fifth tab 120, “Find Land”, or may have selected a similar link, such as the “Find Land” button 230 on the eighth page 210. Once the user decides to search for land, the program 3 displays a tenth page 250 as shown on FIG. 23. The tenth page 250 includes a button that will provide a means to allow a realtor to contact the user 252 or an on-line search 254 for land. If the user selects the on-line search 254, the program 3 provides an input box 256 for the user to input a zip code, a search radius box 258 that allows the user to input a radius, a lot size input box 260 that allows the user to select a lot size, and a price input box 262 that allows the user to select a lot size. After the user performs an on-line search 254, the program 3 returns an eleventh page 263 that includes a list 264 of available property, as shown in FIG. 23A. At this point, the program 3 again allows the realtor to contact the user 252, submit another on-line search 254, or link to other sites 266 that provide information on the property that fits the user selected criteria. The other sites 266 are typically provided by realtors affiliated with the service provider.

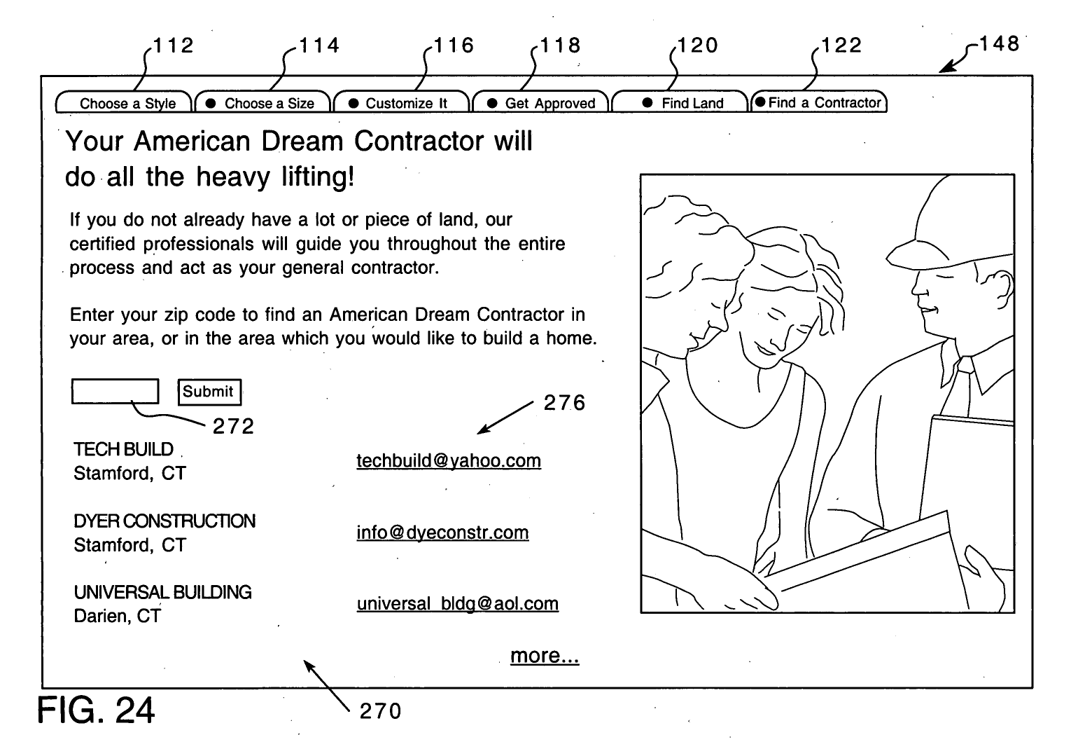

As shown in FIG. 24, when the user selects the sixth tab 122, “Find a Contractor”, or the “Find a Contractor” button 232 on the eighth page 210, the program 3 displays a twelfth page 270 structured to assist the user in contacting a contractor screen. The program allows the user to enter a zip code in an in-put box 272. The program 3 then returns a list 276 of contractors affiliated with the provider.

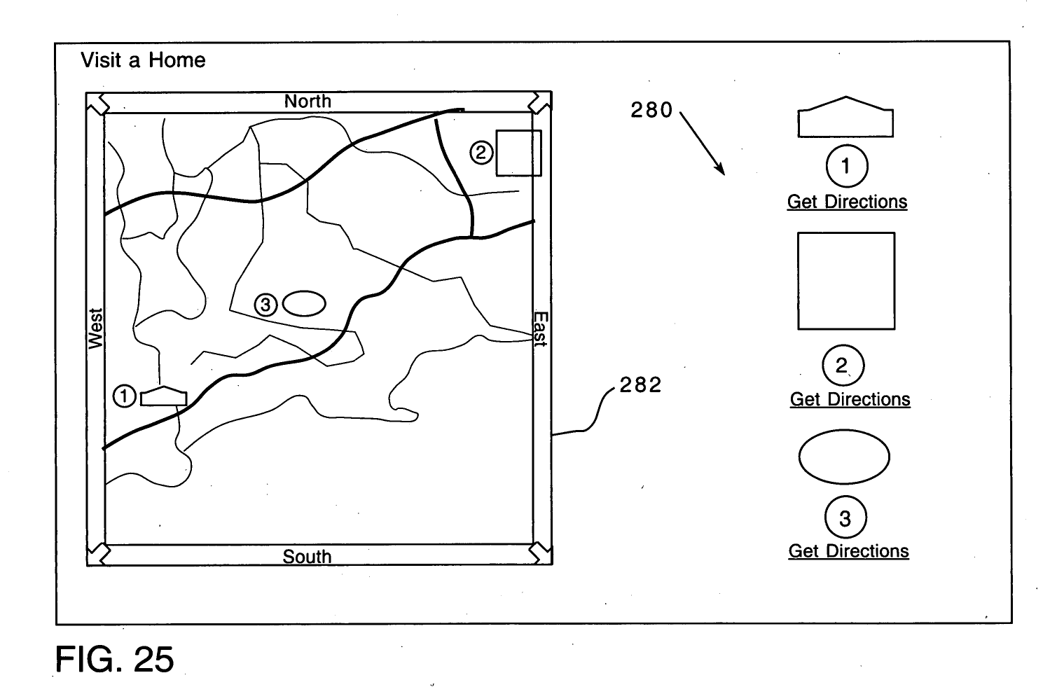

The program 3 may also be structured to provide a user with directions to a model home. That is, as shown on FIG. 25, the program may display a thirteenth page 280 having a map image 282 of the location of a model home. The database 2 may include such map images 282 and be updated as additional homes are built.

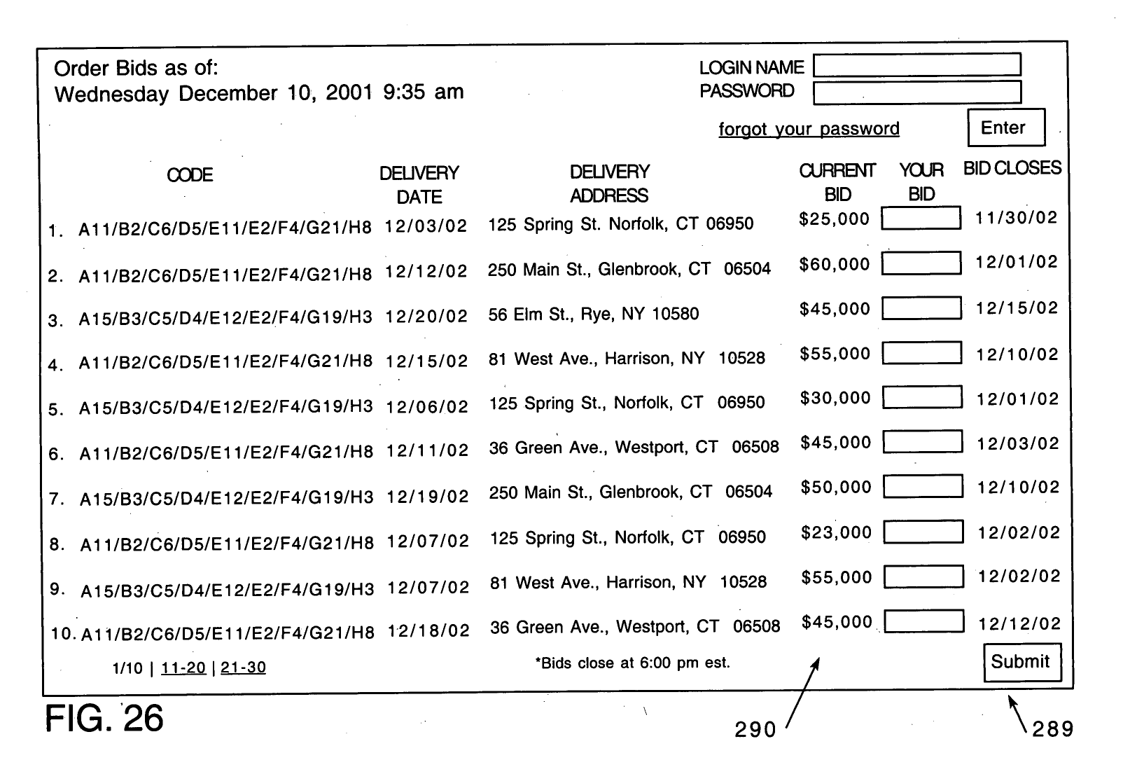

The method may further include a step of ordering the component parts to the house from a manufacturer 98. That is, the program 3 may further be structured to communicate orders to third party manufacturers. With this software not only do the manufacturers know exactly what their costs are but they can respond quickly to orders. Vertical integration from supplier to manufacturer to user afforded in part by the front end of this software takes out guess work, provides accurate numbers which allows the comfortable lowering of margins for volume pricing discounts and ultimately lower prices to consumers. As shown in FIG. 26, the program 3 also displays a fourteenth page 289 that includes pricing information 290 for a number of pending orders. Because the physical homebuilding system is broken down into room groups and option packages, each can be assigned a code and therefore a price, this component is not part of the consumer interface but is relevant to the software/website nevertheless. A bid form system goes out to approved factories, with the order, delivery address and room group codes, all of which have been originally input by the consumer.

Approved manufactures may access the database and read the cost against material labor and time sheets. The manufacturers are, therefore, able to bid on the home. The software provides a detailed description of the options for the home to be built, therefore the factory may determine their cost of materials down to the nail for each product code. Also they input other variables to arrive at their true cost.

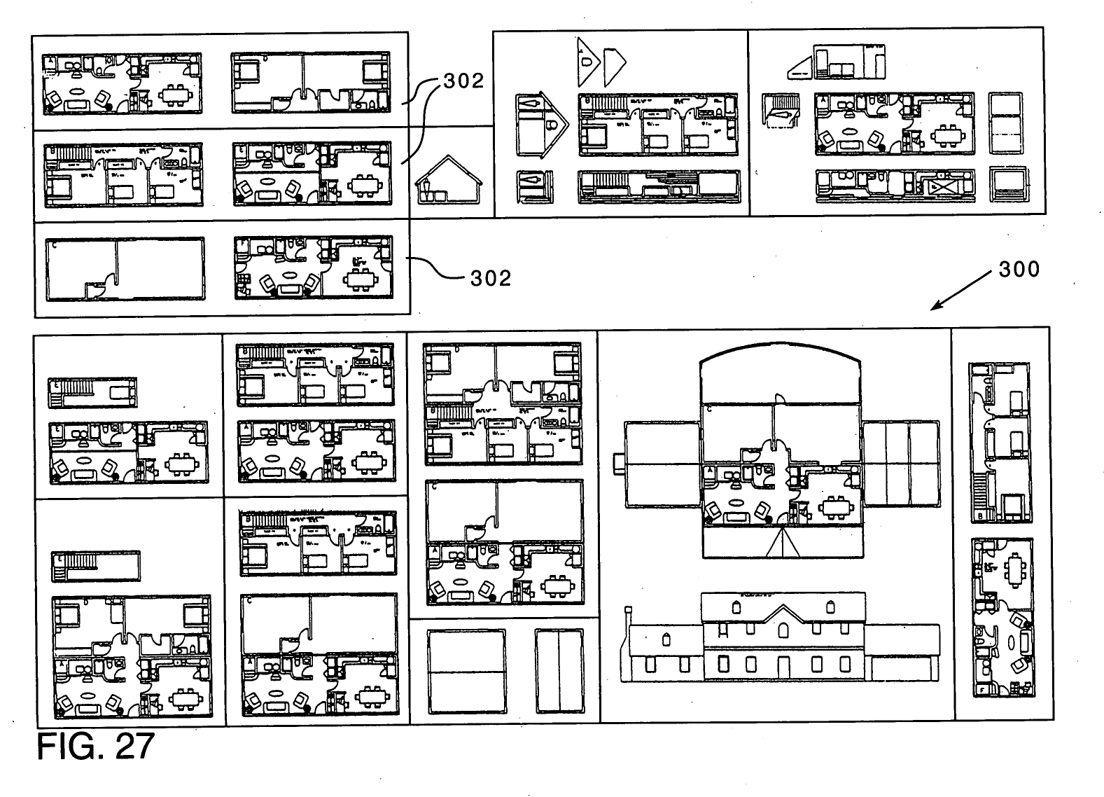

As shown in FIG. 27, the program 3 may further display a fifteenth page 300 having additional floor plan modules 302. The program 3 allows the user to select additional variations to the home. That is, for example, the user may select a floor plan with a different point of design entry. The program displays floor plans for a plurality of box modules and accessories. The user may drag the image of a module down to a main house image. When doorways or connection points approximately align they will automatically snap together. As with other aspect of the program 3 discussed above, as the floor plan modules are added to the main image, the image is updated

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

1. A method of selling custom prefabricated houses to a user, said method comprising the steps of:
a) displaying an image of a prefabricated house and an associated price along with a means to allow said user to select options to said house;
b) allowing said user to select optional components to said house;
c) displaying an image of said house with said user selected options included in said image and displaying a price associated with said house with user selected options; and
d) storing said user selection for later retrieval.

2. The method of claim 1, wherein said step of displaying an image of said prefabricated house and said step of displaying an image of said house with said user selected options included in said image and displaying a price associated with said house with user selected options, include the steps of:
a) displaying an image of a house along with a plurality of options that may be incorporated into the house;
b) allowing said user to select one of said related options;
c) redisplaying said image of a house with said user selected option included; and
d) repeating steps a-c until said user has made a selection from each set of options.

3. The method of claim 2, wherein said step of displaying an image of said prefabricated house and said step of displaying an image of said house with said user selected options included in said image and displaying a price associated with said house with user selected options, include the step of providing a means to convert said image of said house into a floor plan of said house, said floor plan showing all said user selected options.

4. The method of claim 3, wherein said step of displaying an image of said prefabricated house and said step of displaying an image of said house with said user selected options included in said image and displaying a price associated with said house with user selected options, include the step of displaying said floor plan as a two-dimensional image.

5. The method of claim 3, wherein said step of displaying an image of said prefabricated house and said step of displaying an image of said house with said user selected options included in said image and displaying a price associated with said house with user selected options, include the step of:
displaying said floor plan as a three-dimensional image.

6. The method of claim 3, wherein said step of displaying an image of said prefabricated house and said step of displaying an image of said house with said user selected options included in said image and displaying a price associated with said house with user selected options, include the steps of:
displaying a three-dimensional image of the house; and
allowing the user to rotate the three-dimensional image.

7. The method of claim 2, wherein said step of storing said user selection for later retrieval further allows the user to print a summary of details of said house.

8. The method of claim 2, wherein said steps of displaying an image of a house along with a plurality of options that may be incorporated into the house and redisplaying said image of a house with said user selected option included, include the steps of:
a) displaying a price of the house and any selected options; and
b) updating said price along with said image as said user selects additional components.

9. The method of claim 2, wherein said step of displaying a price and said step of updating said price includes the steps of:
determining the present interest rate on a mortgage; and
displaying the price as an estimated monthly payment, said estimate being based on the price of said house.

10. The method of claim 1 wherein said method further comprises an optional step selected from the group comprising: applying for a home loan, finding land upon which the user may build said house, or finding a contractor to build said house.

11. A computer implemented method for selling custom prefabricated houses, said method comprising the steps:
a) providing a computer database which includes data representing price charts and images, said price data and images representing various components of said prefabricated house;
b) allowing a user to access said database via a computer and a communications medium;
c) displaying an image of a prefabricated house and an associated price along with a means to allow said user to select options to said house;
d) allowing said user to select optional components to said house;
e) displaying an image of said house with said user selected options included in said image and displaying a price associated with said house with user selected options; and
f) storing said user selection for later retrieval.

12. The method of claim 11, wherein said step of displaying an image of said prefabricated house and said step of displaying an image of said house with said user selected options included in said image and displaying a price associated with said house with user selected options, include the steps of:
a) displaying an image of a house along with a plurality of options that may be incorporated into the house;
b) allowing said user to select one of said related options;
c) redisplaying said image of a house with said user selected options included; and
d) repeating steps a-c until said user has made a selection from each set of options.

13. The method of claim 12, wherein said step of displaying an image of said prefabricated house and said step of displaying an image of said house with said user selected options included in said image and displaying a price associated with said house with user selected options, include the step of providing a means to convert said image of said house into a floor plan of said house, said floor plan showing all said user selected options.

14. The method of claim 13, wherein said step of displaying an image of said prefabricated house and said step of displaying an image of said house with said user selected options included in said image and displaying a price associated with said house with user selected options, include the step of displaying said floor plan as a two-dimensional image.

15. The method of claim 13, wherein said step of displaying an image of said prefabricated house and said step of displaying an image of said house with said user selected options included in said image and displaying a price associated with said house with user selected options, include the step of displaying said floor plan as a three-dimensional image.

16. The method of claim 13, wherein said step of displaying an image of said prefabricated house and said step of displaying an image of said house with said user selected options included in said image and displaying a price associated with said house with user selected options, include the steps of:
displaying a three-dimensional image of the house; and
allowing the user to rotate the three-dimensional image.

17. The method of claim 12, wherein said step of storing said user selection for later retrieval further allows the user to print a summary of details of said house.

18. The method of claim 12, wherein said steps of displaying an image of a house along with a plurality of options that may be incorporated into the house and redisplaying said image of a house with said user selected options included, include the steps of:
a) displaying a price of the house and any selected options; and
b) updating said price along with said image as said user selects additional components.

19. The method of claim 12, wherein said step of displaying a price and said step of updating said price includes the steps of:
determining the present interest rate on a mortgage; and
displaying the price as an estimated monthly payment, said estimate being based on the price of said house.

20. The method of claim 11 wherein said method further comprises an optional step selected from the group comprising: applying for a home loan, finding land upon which the user may build said house, or finding a contractor to build said house.

21. A computer system containing instructions for performing a method for selling custom prefabricated houses, said method comprising the steps of:
a) providing a computer database which includes data representing price charts and images, said price data and images representing various components of said prefabricated house;
b) allowing a user to access said database via a computer and a communications medium;
c) displaying an image of a prefabricated house and an associated price along with a means to allow said user to select options to said house;
d) allowing said user to select optional components to said house;
e) displaying an image of said house with said user selected options included in said image and displaying a price associated with said house with user selected options; and
f) storing said user selection for later retrieval.

22. The method of claim 21, wherein said step of displaying an image of said prefabricated house and said step of displaying an image of said house with said user selected options included in said image and displaying a price associated with said house with user selected options, include the steps of:
a) displaying an image of a house along with a plurality of options that may be incorporated into the house;
b) allowing said user to select one of said related options;
c) redisplaying said image of a house with said user selected option included; and
d) repeating steps a-c until said user has made a selection from each set of options.

23. The method of claim 22, wherein said step of displaying an image of said prefabricated house and said step of displaying an image of said house with said user selected options included in said image and displaying a price associated with said house with user selected options, include the step of providing a means to convert said image of said house into a floor plan of said house, said floor plan showing all said user selected options.

24. The method of claim 23, wherein said step of displaying an image of said prefabricated house and said step of displaying an image of said house with said user selected options included in said image and displaying a price associated with said house with user selected options, include the step of displaying said floor plan as a two-dimensional image.

25. The method of claim 23, wherein said step of displaying an image of said prefabricated house and said step of displaying an image of said house with said user selected options included in said image and displaying a price associated with said house with user selected options, include the step of displaying said floor plan as a three-dimensional image.

26. The method of claim 23, wherein said step of displaying an image of said prefabricated house and said step of displaying an image of said house with said user selected options included in said image and displaying a price associated with said house with user selected options, include the steps of:
displaying a three-dimensional image of the house; and
allowing the user to rotate the three-dimensional image.

27. The method of claim 22, wherein said step of storing said user selection for later retrieval further allows the user to print a summary of details of said house.

28. The method of claim 22, wherein said steps of displaying an image of a house along with a plurality of options that may be incorporated into the house and redisplaying said image of a house with said user selected option included, include the steps of:
a) displaying a price of the house and any selected options; and
b) updating said price along with said image as said user selects additional components.

29. The method of claim 22, wherein said step of displaying a price and said step of updating said price includes the steps of:
determining the present interest rate on a mortgage; and
displaying the price as an estimated monthly payment, said estimate being based on the price of said house.

30. The method of claim 21 wherein said method further comprises an optional step selected from the group comprising: applying for a home loan, finding land upon which the user may build said house, or finding a contractor to build said house.
